(19) United States
(12) Patent Application Publication
(10) Pub. No.: US 2016/0267400 A1
(43) Pub. Date: Sep. 15, 2016

(54) TRAVEL PRODUCT SELECTION AND BOOKING METHOD, DEVICE AND SYSTEM

(71) Applicant: CORPORATE TRAVEL MANAGEMENT GROUP PTY LTD, Brisbane (AU)

(72) Inventor: Thomas Patrick CLARK, Sydney (AU)

(21) Appl. No.: 15/031,549

(22) PCT Filed: Jun. 23, 2014
(86) PCT No.: PCT/AU2014/000645

§ 371 Date: Apr. 22, 2016

(30) Foreign Application Priority Data
Oct. 22, 2013 (AU) 2013904076

(51) Int. Cl. G06Q 10/02; G06Q 30/06

(52) U.S. Cl. CPC G06Q 10/02; G06Q 30/0643

(57) ABSTRACT

Methods, devices, systems and computer program products for receiving a selection of travel product, providing access to booking and/or booking one or more travel products are provided. The method for receiving a selection of one or more travel products comprises providing an initial screen display comprising a time series graphical display of the one or more travel products and receiving an indication of selected one or more travel products present on the graphical display to thereby receive the selection of the one or more travel products. According to the invention, deep linking provides direct access to allow a user to booking the indicated one or more travel products. In one embodiment, the initial screen display is the first screen displayed to a user.

### FIELD OF THE INVENTION

The present invention relates to a travel product selection and/or booking method, device and system. More particularly the invention relates to a method, device and system which display travel products on a time series graphical display.

### BACKGROUND TO THE INVENTION

Travel bookings are frequently made using one or more computer systems. Typically a user or their Agent uses a browser to display a website or an online booking tool (OBT) and enters the desired dates for booking a travel product such as a flights, accommodation or other products associated with travel such as, car hire. The time taken to load the website or OBT, enter the required information and load the results can be significant and frustrating.

Selection of travel products is complicated by many providers having their own sites and OBTs and by the presence of many aggregator sites that display travel products from differing subsets of the many providers.

As a result of these factors, typically it requires a large amount of time to select and make a desired booking. Accordingly, there is a need for improved selection and booking methods, devices and systems.

### SUMMARY OF THE INVENTION

The present invention is broadly directed to a method, device and system for receiving a selection of a travel product, providing access to booking and/or booking one or more travel products. In one embodiment the method, device and system displays travel products using one or more time series graphical displays. Preferred advantages that the method, device and system of the present invention may attain include increased speed of selection, arranging a booking and/or booking and increased ease of navigation and product selection.

In a first aspect, the present invention provides a method for receiving a selection of one or more travel products comprising or consisting of:

providing an initial screen display comprising a time series graphical display of the one or more travel products; and

receiving an indication of selected one or more travel products present on the graphical display to thereby receive the selection of the one or more travel products.

In one embodiment of the first aspect, the method further comprises providing direct access to a booking for the indicated one or more travel products. The direct access may be provided by supplying respective one or more deep links to an online booking tool or other website in which the selected one or more travel products are entered for booking.

In a second aspect, the present invention provides a device for receiving a selection of one or more travel products comprising or consisting of:

at least one server computer operable to provide time series data for one or more travel products over a network to thereby allow presentation on a network connected personal device of an initial screen display comprising a time series graphical display of the one or more travel products; and

at least one computer network interface connected to the at least one server computer and operable to provide access to the network, the interface configured to receive an indication from the personal device of a selection of one or more travel products present on the graphical display.

In one embodiment of the second aspect, the at least one server computer comprises a microprocessor and an associated memory or storage device. The memory or storage device may further comprise instructions executable by the microprocessor such that the server computer is operable to:

(i) provide the time series data; and

(ii) receive the indication.

In another embodiment of the second aspect, the server computer is further operable to supply respective one or more deep links to an online booking tool or other website in which the selected one or more travel products are entered for booking. This provision may be made by the memory or storage device further comprising instructions executable by the microprocessor such that the server computer is operable to: (iii) supply the respective one or more deep links.

In a third aspect, the present invention provides a system for receiving a selection of one or more travel products comprising or consisting of:

at least one server computer providing time series data for one or more travel products over a network to thereby allow presentation on a network connected personal device of an initial screen display comprising a time series graphical display of the one or more travel products; and

at least one computer network interface connected to the at least one server computer and providing access to the network, the interface for receiving an indication from the personal device of selection of one or more travel products present on the graphical display.

In one embodiment of the third aspect, the server computer further supplies respective one or more deep links to an online booking tool or other website in which the selected one or more travel products are entered for booking. This supply may be made by the memory or storage device further comprising instructions executable by the microprocessor such that the server computer is operable to: (iii) supply the respective one or more deep links.

In a fourth aspect, the present invention provides a computer program product for receiving a selection of one or more travel products comprising or consisting of:

a computer usable medium and computer readable program code embodied on said computer usable medium for displaying data, the computer readable code comprising or consisting of:

computer readable program code devices (i) configured to cause a personal device to provide an initial screen display comprising a time series graphical display of one or more travel products; and

computer readable program code devices (ii) configured to cause the personal device to receive an indication from a user of a selection of one or more travel products present on the graphical display.

In one embodiment of the fourth aspect, the computer program product further comprises computer readable program code devices (iii) configured to cause the personal device to send the received indication to a server computer.

In another embodiment of the fourth aspect, the computer program product further comprises computer readable program code devices (iv) configured to cause the personal device to receive one or more respective one or more deep links to an online booking tool or other website in which the selected one or more travel products are entered for booking. The respective one or more deep links may be received from a server computer.

In a fifth aspect, the present invention provides a computer program product for providing time series data for one or more travel products comprising or consisting of:

a computer usable medium and computer readable program code embodied on said computer usable medium for displaying data, the computer readable code comprising:

computer readable program code devices (i) configured to cause at least one server computer to send time series data for one or more travel products to a personal device such that the personal device provides an initial screen display comprising a time series graphical display of the one or more travel products; and

computer readable program code devices (ii) configured to cause the at least one server computer to receive an indication entered on the personal device of a selection of one or more travel products present on the graphical display.

In another embodiment of the fifth aspect the computer program product further comprises computer readable program code devices (iv) configured to cause the at least one server computer to send to the personal device respective one or more deep links to an online booking tool or other website in which the selected one or more travel products are entered for booking.

In a sixth aspect, the present invention provides a method for providing access to a booking of one or more travel products comprising or consisting of:

providing an initial screen display comprising a time series graphical display of the one or more travel products;

receiving an indication of selected one or more travel products present on the graphical display; and

supplying respective one or more deep links to an online booking tool or site in which the selected one or more travel products are entered for booking.

In a seventh aspect, the present invention provides a device for providing access to a booking of one or more travel products comprising or consisting of:

at least one server computer operable to provide time series data for one or more travel products over a network to thereby allow presentation on a network connected personal device of an initial screen display comprising a time series graphical display of the one or more travel products; and

at least one computer network interface connected to the at least one server computer and operable to provide access to the network, the interface configured to receive an indication from the personal device of a selection of one or more travel products present on the graphical display and to supply to the personal device respective one or more deep links to an online booking tool or other website in which the selected one or more travel products are entered for booking.

In one embodiment of the seventh aspect, the at least one server computer comprises a microprocessor and an associated memory or storage device. The memory or storage device may further comprise instructions executable by the microprocessor such that the server computer is operable to:

(i) provide the time series data;

(ii) receive the indication; and

(iii) supply the respective one or more deep links.

In a eighth aspect, the present invention provides a system for providing access to a booking of one or more travel products comprising or consisting of:

at least one server computer providing time series data for one or more travel products over a network to thereby allow presentation on a network connected personal device of an initial screen display comprising a time series graphical display of the one or more travel products; and

at least one computer network interface connected to the at least one server computer and providing access to the network, the interface for receiving an indication from the personal device of selection of one or more travel products present on the graphical display and for supplying to the personal device respective one or more deep links to an online booking tool or other website in which the selected one or more travel products are entered for booking.

In an ninth aspect, the present invention provides a computer program product for providing access to a booking of one or more travel products comprising or consisting of:

a computer usable medium and computer readable program code embodied on said computer usable medium for displaying data, the computer readable code comprising:

computer readable program code devices (i) configured to cause a personal device to provide an initial screen display comprising a time series graphical display of one or more travel products;

computer readable program code devices (ii) configured to cause the personal device to receive an indication from a user of a booking of one or more travel products present on the graphical display and to send the received indication to one or more server computers; and

computer readable program code devices (iii) configured to cause the personal device to receive from the server computer respective one or more deep links to an online booking tool or other website in which the selected one or more travel products are entered for booking.

In an tenth aspect, the present invention provides a computer program product for providing direction to a site for booking one or more travel products comprising or consisting of:

a computer usable medium and computer readable program code embodied on said computer usable medium for displaying data, the computer readable code comprising:

computer readable program code devices (i) configured to cause at least one server computer to send time series data for one or more travel products to a personal device such that the personal device provides an initial screen display comprising a time series graphical display of the one or more travel products;

computer readable program code devices (ii) configured to cause the at least one server computer to receive an indication entered on the personal device of a selection of one or more travel products present on the graphical display;

computer readable program code devices (iii) configured to cause the at least one server computer to supply to the personal device respective one or more deep links to an online booking tool or other website in which the selected one or more travel products are entered for booking.

In a eleventh aspect, the present invention provides a method for booking one or more travel products comprising or consisting of:

providing an initial screen display comprising a time series graphical display of the one or more travel products;

receiving an indication of selected one or more travel products present on the graphical display;

supplying respective one or more deep links to an online booking tool or site in which the selected one or more travel products are entered for booking; and

booking the selected one or more travel products on the online booking tool or site to thereby book the one or more travel products.

In a twelfth aspect, the present invention provides a system for booking one or more travel products comprising or consisting of:

at least one server computer providing time series data for one or more travel products over a network to thereby allow presentation on a network connected personal device of an initial screen display comprising a time series graphical display of the one or more travel products;

at least one computer network interface connected to the at least one server computer and providing access to the network, the interface for receiving an indication from the personal device of selection of one or more travel products present on the graphical display and for providing to the personal device respective one or more deep links to an online booking tool or other website in which the selected one or more travel products are entered for booking; and

a host server computer hosting the online booking tool or other website for receiving the booking of the one or more travel products.

According to one embodiment of the twelfth aspect, the host server computer may be operated by a provider of the one or more travel products or a booking agent.

In an thirteenth aspect, the present invention provides a computer program product for booking one or more travel products comprising or consisting of:

a computer usable medium and computer readable program code embodied on said computer usable medium for displaying data, the computer readable code comprising:

computer readable program code devices (i) configured to cause a personal device to provide an initial screen display comprising a time series graphical display of one or more travel products;

computer readable program code devices (ii) configured to cause the personal device to receive an indication from a user of a selection of one or more travel products present on the graphical display and to send the received indication to one or more server computers;

computer readable program code devices (iii) configured to cause the personal device to receive from the server computer respective one or more deep links to an online booking tool or other website in which the selected one or more travel products are entered for booking; and

computer readable program code devices (iv) configured to receive from the personal device a booking of the one or more travel product.

In a fourteenth aspect, the present invention provides a computer program product for booking or facilitating a booking of one or more travel products comprising or consisting of:

a computer usable medium and computer readable program code embodied on said computer usable medium for displaying data, the computer readable code comprising:

computer readable program code devices (i) configured to cause at least one server computer to send time series data for one or more travel products to a personal device such that the personal device provides an initial screen display comprising a time series graphical display of the one or more travel products;

computer readable program code devices (ii) configured to cause the at least one server computer to receive an indication entered on the personal device of a selection of one or more travel products present on the graphical display;

computer readable program code devices (iii) configured to cause the at least one server computer to provide to the personal device respective one or more deep links to an online booking tool or other website in which the selected one or more travel products are entered for booking; and

computer readable program code devices (iv) configured to receive from the personal device across a network a booking of the one or more travel products.

In one embodiment of the fourteenth aspect, code devices (iv) are stored on a server computer operated by a provider of the one or more travel products that is booked.

In one embodiment of any above aspect the initial screen display is the first screen displayed to a user upon opening an application programme or opening a website. The application programme may comprise an app or a widget.

In another embodiment of any above aspect, the graphical display presents a price of the travel product over the time series. When the graphical display is limited to one value per day, the lowest price for that day may be displayed.

In yet another embodiment of any above aspect, the graphical display presents a demand or a price over the time series. There may be a toggle button to change between the demand and the price. The demand may be calculated according to a demand algorithm. The demand algorithm may comprise averaging the price for each day of the week over future months to calculate a benchmark for each weekday and comparing the price for a displayed date with the benchmark for that weekday. In a preferable embodiment the toggle button is comprised on graphical displays presenting a demand for accommodation.

According to any above aspect, the time series graphical display may comprise one or more indicators of selection drivers. The one or more indicators may comprise one or more of a first colour indicating a desirable selection driver; a second colour indicating an undesirable selection driver; and a third colour indicating a moderate selection driver. The desirable selection driver may comprise an inexpensive price and/or low demand. The undesirable selection driver may comprise an expensive price and/or high demand. The moderate selection driver may comprise a price that is neither low or high and/or demand that is neither high or low. The desirable selection driver may be coloured green. The undesirable selection driver may be coloured red. The moderate selection driver may be coloured blue.

According to any above aspect, respective product information associated with each of the one or more travel products is received by and/or stored on the personal device and/or at least one server computer. Each respective product information may comprise one or more of price; availability; time of day; date; stopover details; provider, flight number; and alternate airline or accommodation provider offering in that time period.

In a preferred embodiment of any above aspect, one or more of the each product information is received on the personal device from the at least one server computer and/or a remote server computer over a network.

The product information may be received and/or stored on the personal device or the at least one server computer.

In a preferred embodiment of any above aspect, one or more of the each product information is received on the at least one server computer from a remote server computer over a network.

The product information may be received from a provider, a booking agent or an aggregator or computer reservations system. According to any above aspect, the product information may be received at a regular frequency. The frequency may comprise every one, two, three, four, five, six, seven, eight, nine, ten, eleven or twelve hours; or every one, two, three, four, five, six or seven days.

According to any above aspect, one or more default parameters may be applied to restrict the time series graphical display. The one or more default parameters may be stored on and/or accessed from the personal device and/or stored on and/or received from a memory or storage device associated with the server computer.

According to any above aspect, the default parameter may comprise one or more of a preferred airline; a time of day; a departure point; an arrival point; a location; a preferred provider, a default date; a price point or range; a city; stopover details; flight number; alternate airline or accommodation provider offering in the same time period; all day offering based on each hour of the day.

According to any above aspect, customer-specific information may be applied to restrict the time series graphical display. The customer-specific information may be stored on and/or accessed from the personal device and/or stored on and/or received from a memory or storage device associated with a server computer. The customer-specific information may comprise one or more of present location; and club membership information. The club membership information may comprise one or more of club name; membership number, and membership level.

According to any above aspect, the initial screen display may also comprise one or more selectable filters. The one or more selectable filters may restrict respective one or more travel products. The filter may comprise one or more of a time period; rates; a provider, a preferred provider; a time of day; a departure point; an arrival point; a location; a price point; price range; or a star rating. Each of the one or more selectable filters may be settable by a user or administrator or may comprise a drop down menu.

According to any above aspect, one or more profiles may be associated with a user. Each one or more profiles may store default parameters; customer-specific information; one or more selectable filters and/or number and type of time series graphical displays to provide on the initial screen display. The one or more profiles may comprise a work profile; a personal profile; an international profile; and a domestic profile. Each one or more profiles may be stored on the personal device or the server computer.

According to any above aspect the time-series may be dated from a default date to until a defined period thereafter. The defined period may comprise one, two, three, four, five, six, seven, eight, nine or ten days thereafter; or two, three or four weeks later. In a particular embodiment the defined period is three weeks later. The default date may comprise the current day or the next day. In another particular embodiment, the default date comprises the next day.

According to any above aspect, each of the one or more travel products may comprise a flight, accommodation, car hire or a transfer service. The transfer service may for example be a service providing transfer from an arrival point to accommodation and/or from accommodation to a departure point.

According to any above aspect the received selection may comprise a date for the one or more travel products.

According to any above aspect, the deep linked online booking tool or other website may be operated by a provider of the selected one or more travel products or by a third party.

According to the first, fifth and ninth aspects the initial screen display may be provided on a personal device.

According to the first, fifth and ninth aspects the indication may be entered onto the personal device and/or received by at least one server computer via a network.

According to any above aspect, the personal device may comprise a desktop computer or a mobile device. The mobile device may comprise a smart phone, a note book computer; a tablet computer; or a phablet device.

According to any above aspect, time series data used to construct the time series graphical display may be received by the personal device from the at least one server computer. The receiving of the time series data may be in response to a query from the personal device.

In one embodiment of any above aspect, the initial screen display comprises two or more time series graphical displays. The two or more time series graphical displays may comprise an outbound flight display and a return flight display.

In another embodiment of any above aspect, the initial screen display comprises three time series graphical displays. The three time series graphical displays may comprise an outbound flight display; a return flight display; and an accommodation display. The accommodation display comprises one or more accommodation products for a location and time corresponding to the outbound and return flights.

According to any above aspect, the received one or more deep links may open automatically on the personal device.

Where the terms “comprise”, comprises”, “comprising”, “include”, “includes”, “included” or “including” are used in this specification, they are to be interpreted as specifying the presence of the stated features, integers, steps or components referred to, but not to preclude the presence or addition of one or more other features, integers, steps, components or group thereof.

Further, any prior art reference or statement provided in the specification is not to be taken as an admission that such art constitutes, or is to be understood as constituting, part of the common general knowledge.

### BRIEF DESCRIPTION OF THE FIGURES

In order that the present invention may be readily understood and put into practical effect, reference will now be made to the accompanying illustrations, wherein like reference numerals refer to like features and wherein:

FIG. 1: shows one embodiment of an initial display according to the invention.

FIG. 2A: shows one embodiment of a computer system suitable for use in invention.

FIG. 2B: shows one embodiment of a computer memory and processor suitable for use in the invention.

FIGS. 3A-3C: are flowcharts showing different embodiments of a method according to the invention.

### DETAILED DESCRIPTION OF THE INVENTION

The present invention broadly provides a method, device and system for receiving a selection of one or more travel products, providing access to a booking and/or booking one or more travel products. Advantageously, the one or more travel products are displayed using one or more time series graphical displays. By presenting the products in this manner the method, device and system of the present invention allows increased speed of selection, provision of access to a booking and/or booking and increased ease of navigation and product selection.

Through diligent study the inventors have discovered that by displaying one or more travel products using a time series graphical display, not only is the identification of a desired travel product made quicker and easier, but also the time taken to access and book the travel product is reduced.

The described travel product selection and booking methods, devices and systems comprise, in one arrangement, at least one server computer in communication across a network with a personal device such as, a personal computer or a smartphone.

The personal device is used to present the time series graphical display to a user. The user can then indicate the one or more travel products they select, for example, by clicking a mouse or touching a touchscreen on the part of the graphical display representing the selected product.

The at least one server computer may provide respective product information associated with the one or more travel products represented on the graphical display to the personal device through the network.

The following description refers to specific embodiments of the present invention and is in no way intended to limit the scope of the present invention to those specific embodiments.

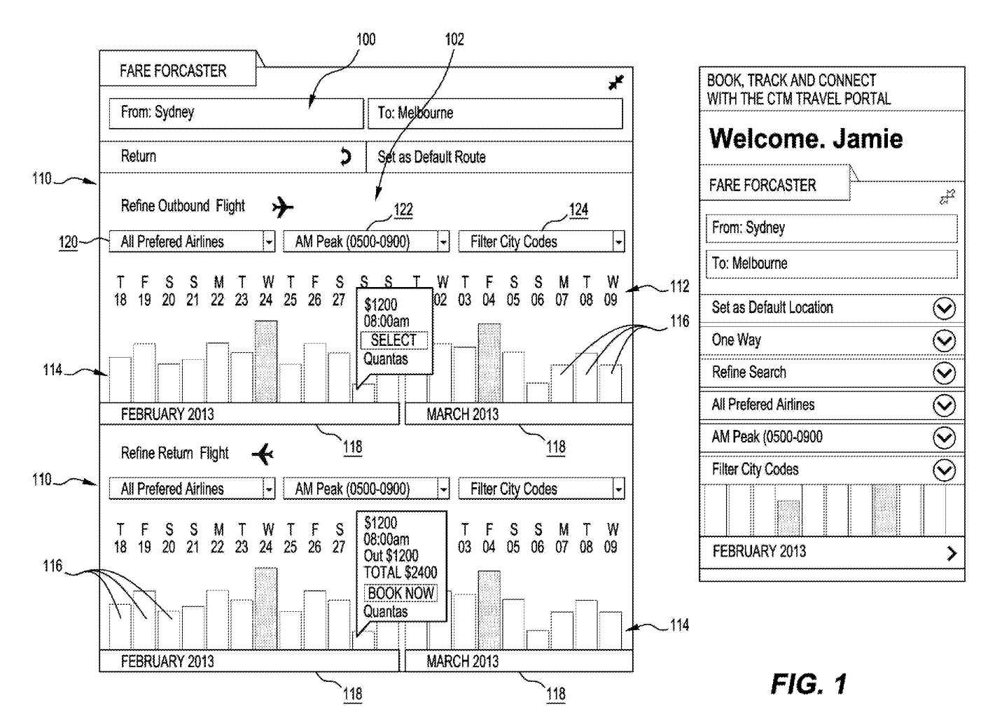

FIG. 1 shows example time series graphical displays 110 according to one embodiment of the invention. The top graphical display 110 is for an outbound flight from Sydney to Melbourne. The bottom graphical display 110 is for a return flight. Graphical displays 110 are presented within graphical user interface 100 and are comprised on initial screen display 102. In FIG. 1, both graphical displays 110 are bar graphs 114 in which the date is shown on the x-axis and the price is shown on the y-axis. The scale of the x-axis and/or y-axis may be dynamic.

As will be appreciated by the skilled person, displays 110 comprise a time series that is for a future time period or for a present day plus future time period.

Each bar 116 comprised on graphs 110 represents a particular day. The date and day of the week of that particular date is shown on an aligned linear key 112 extending above each bar. The month 118 that each day is in is shown at the bottom of the bar graph 114.

The present invention is of significant advantage to those who wish to make a booking for a travel product because the graphical display 110 is on the first screen displayed to a user upon opening an application program or opening a website according to the invention. Although an application or a website may have a start up screen, the initial screen display is the first screen displayed that a user may interact with.

Because the graphical display 110 is presented on the first screen displayed to a user, it is possible for a selection or booking to be made by a user without entering any data. As will be explained below, graphical display 110 may be informed by one or more defaults stored on a user's personal computing device or on a server computer.

This feature of the invention, and the deep linking described below, result in a time saving of approximately 30 seconds per booking. This time saving is seen as significant to users.

In other embodiments, initial screen display 102 comprises three time series graphical displays 110. A first time series graphical display 110 comprising an outbound flight; a second time series graphical display 110 comprising a return flight; and a third time series graphical display 110 comprising an accommodation product. The accommodation product is for one or more accommodation products for a location and time corresponding to the outbound and return flights. Advantageously, this embodiment of the present invention allows the booking of return flights and corresponding accommodation in a convenient three step process all conducted through the first screen display viewed by a user.

The application program may comprise an “app” or a “widget”. As will be described below the invention provides various code devices that may reside on a user's personal device and/or on a provider's server computer.

In embodiments, like that shown in FIG. 1, where graphical display 110 presents a price of the travel product over the time series, when graphical display 110 is limited to one value per day, the lowest price for that day may be displayed.

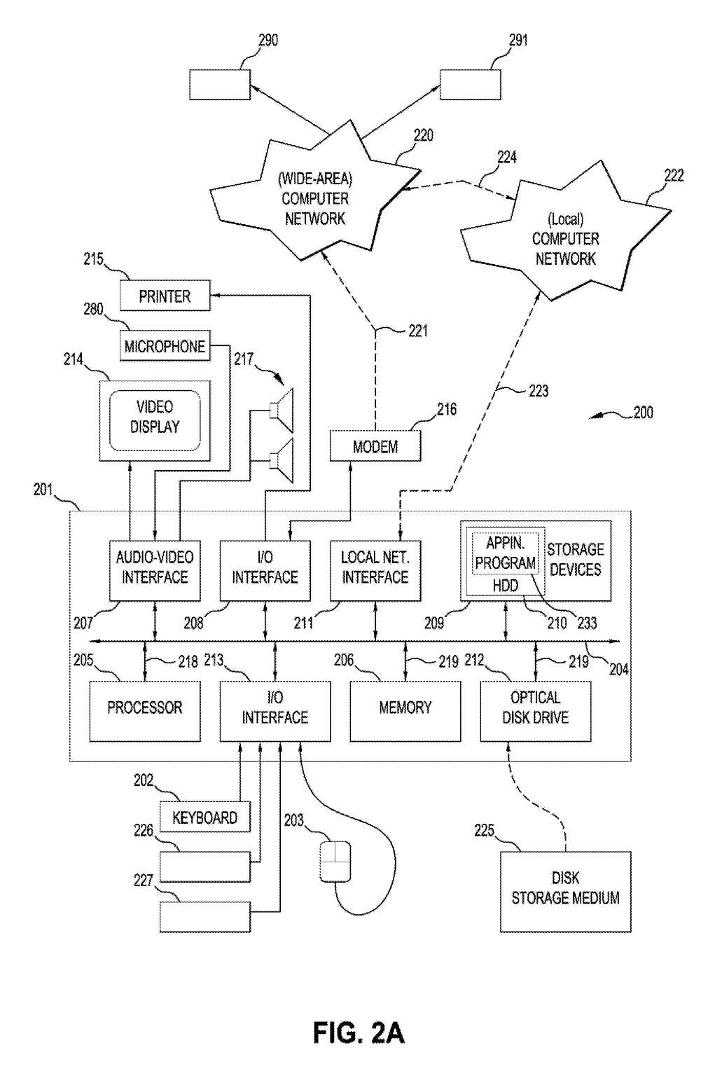

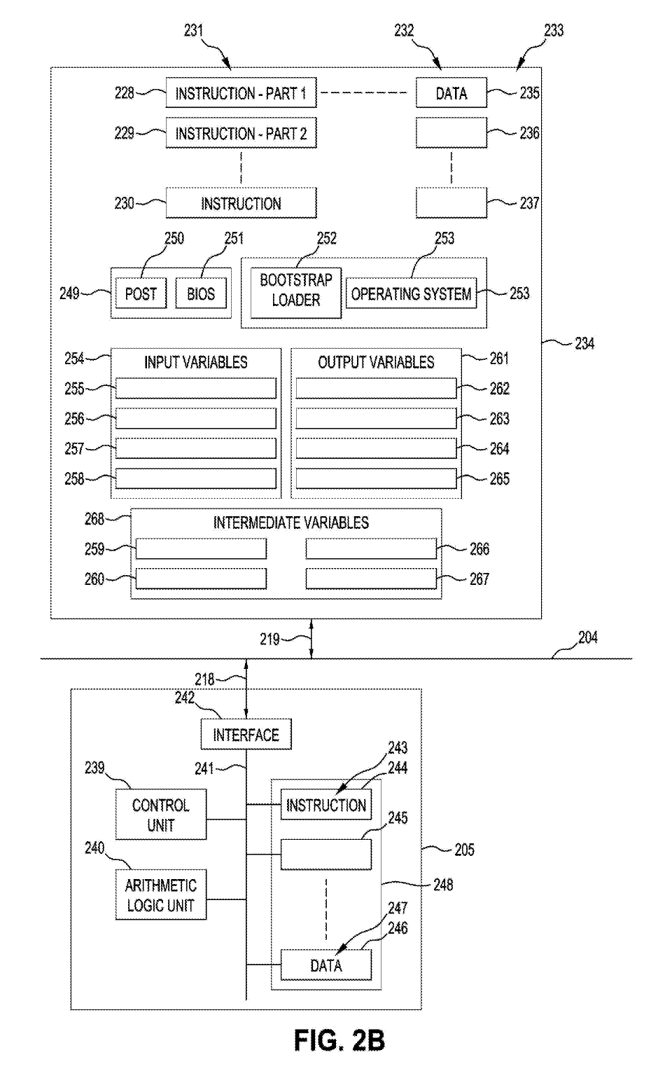

One embodiment of a personal device 200 suitable for use in the present invention is shown in FIGS. 2A and 2B. In the embodiment shown personal device 200 comprises a computer module 201 comprising input devices such as a keyboard 202, a mouse pointer device 203, a scanner 226, an external hard drive 227, and a microphone 280; and output devices including a printer 215, a display device 214 and loudspeakers 217. In some embodiments video display 214 may comprise a touchscreen.

A Modulator-Demodulator (Modem) device 216 may be used by the computer module 201 for communicating to and from a communications network 220 via a connection 221. The network 220 may be a wide-area network (WAN), such as the Internet, a cellular telecommunications network, or a private WAN. Through the network 220, computer module 201 may be connected to a booking tool host server computer 290 and/or travel product server computer 291. Where the connection 221 is a telephone line, the modem 216 may be a traditional “dial-up” modem. Alternatively, where the connection 221 is a high capacity (e.g.: cable) connection, the modem 216 may be a broadband modem. A wireless modem may also be used for wireless connection to network 220.

The computer module 201 typically includes at least one processor 205, and a memory 206 for example formed from semiconductor random access memory (RAM) and semiconductor read only memory (ROM). The module 201 also includes a number of input/output (I/O) interfaces including: an audio-video interface 207 that couples to the video display 214, loudspeakers 217 and microphone 280; an L/O interface 213 for the keyboard 202, mouse 203, scanner 226 and external hard drive 227; and an interface 208 for the external modem 216 and printer 215. In some implementations, modem 216 may be incorporated within the computer module 201, for example within the interface 208. The computer module 201 also has a local network interface 211 which, via a connection 223, permits coupling of the personal device 200 to a local computer network 222, known as a Local Area Network (LAN).

As also illustrated, the local network 222 may also couple to the wide network 220 via a connection 224, which would typically include a so-called “firewall” device or device of similar functionality. The interface 211 may be formed by an Ethernet circuit card, a Bluetooth wireless arrangement or an IEEE 802.11 wireless arrangement or other suitable interface.

The I/O interfaces 208 and 213 may afford either or both of serial and parallel connectivity, the former typically being implemented according to the Universal Serial Bus (USB) standards and having corresponding USB connectors (not illustrated).

Storage devices 209 are provided and typically include a hard disk drive (HDD) 210. Other storage devices such as, an external HD 227, a disk drive (not shown) and a magnetic tape drive (not shown) may also be used. An optical disk drive 212 is typically provided to act as a non-volatile source of data. Portable memory devices, such as optical disks (e.g.: CD-ROM, DVD, Blu-Ray Disc), USB-RAM, external hard drives and floppy disks for example, may be used as appropriate sources of data to the personal device 200. Another source of data to personal device 200 is provided by the at least one server computer 291 through network 220.

The components 205 to 213 of the computer module 201 typically communicate via an interconnected bus 204 in a manner which results in a conventional mode of operation of personal device 200. In the embodiment shown in FIGS. 2A and 2B, processor 205 is coupled to system bus 204 through connections 218. Similarly, memory 206 and optical disk drive 212 are coupled to the system bus 204 by connections 219. Examples of personal devices 200 on which the described arrangements can be practiced include IBM-PC's and compatibles, Sun Spare stations, Apple computers; smart phones; tablet computers or a like device comprising a computer module like computer module 201.

Display device 214 may comprise a touchscreen. This is commonplace for smart phones, phablet devices, tablet computers and notebook computers. When display device comprises a touchscreen, the other input and output devices may not be included such as, mouse pointer device 201; keyboard 202; scanner 226; and printer 215.

FIG. 2B is a detailed schematic block diagram of processor 205 and a memory 234. The memory 234 represents a logical aggregation of all the memory modules, including the storage device 209 and semiconductor memory 206, which can be accessed by the computer module 201 in FIG. 2A.

The methods of the invention may be implemented using personal device 200 wherein the methods may be implemented as one or more software application programs 233 executable within computer module 201. In particular, the steps of the methods of the invention may be effected by instructions 231 in the software carried out within the computer module 201

The software instructions 231 may be formed as one or more code modules, each for performing one or more particular tasks. The software 233 may also be divided into two separate parts, in which a first part and the corresponding code modules performs the method of the invention and a second part and the corresponding code modules manage a graphical user interface between the first part and the user.

The software 233 may be stored in a computer readable medium, including in a storage device of a type described herein. The software is loaded into the personal device 200 from the computer readable medium or through network 221 or 223, and then executed by personal device 200. In one example the software 233 is stored on storage medium 225 that is read by optical disk drive 212. Software 233 is typically stored in the HDD 210 or the memory 206.

A computer readable medium having such software 233 or computer program recorded on it is a computer program product.

In some instances, the software application programs 233 may be supplied to the user encoded on one or more disk storage mediums 225 such as a CD-ROM, DVD or Blu-Ray disc, and read via the corresponding drive 212, or alternatively may be read by the user from the networks 220 or 222. Still further, the software can also be loaded into the personal device 200 from other computer readable media. Computer readable storage media refers to any non-transitory tangible storage medium that provides recorded instructions and/or data to the computer module 201 or personal device 200 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software application programs 233, instructions 231 and/or data to the computer module 201 include radio or infra-red transmission channels as well as a network connection 221, 223, 334, to another computer or networked device 290, 291 and the Internet or an Intranet including email transmissions and information recorded on Websites and the like.

The second part of the application programs 233 and the corresponding code modules mentioned above may be executed to implement one or more graphical user interfaces (GUIs) to be rendered or otherwise represented upon display 214. Through manipulation of, typically, keyboard 202, mouse 203 and/or screen 214 when comprising a touchscreen, a user of personal device 200 and the methods of the invention may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers 217 and user voice commands input via microphone 280. The manipulations including mouse clicks, screen touches, speech prompts and/or user voice commands may be transmitted via network 220 or 222.

When the computer module 201 is initially powered up, a power-on self-test (POST) program 250 may execute. The POST program 250 is typically stored in a ROM 249 of the semiconductor memory 206. A hardware device such as the ROM 249 is sometimes referred to as firmware. The POST program 250 examines hardware within the computer module 201 to ensure proper functioning, and typically checks processor 205, memory 234 (209, 206), and a basic input-output systems software (BIOS) module 251, also typically stored in ROM 249, for correct operation. Once the POST program 250 has run successfully, BIOS 251 activates hard disk drive 210. Activation of hard disk drive 210 causes a bootstrap loader program 252 that is resident on hard disk drive 210 to execute via processor 205. This loads an operating system 253 into RAM memory 206 upon which operating system 253 commences operation. Operating system 253 is a system level application, executable by processor 205, to fulfill various high level functions, including processor management, memory management, device management, storage management, software application interface, and generic user interface.

Operating system 253 manages memory 234 (209, 206) in order to ensure that each process or application running on computer module 201 has sufficient memory in which to execute without colliding with memory allocated to another process. Furthermore, the different types of memory available in the personal device 200 must be used properly so that each process can run effectively. Accordingly, the aggregated memory 234 is not intended to illustrate how particular segments of memory are allocated, but rather to provide a general view of the memory accessible by computer module 201 and how such is used.

Processor 205 includes a number of functional modules including a control unit 239, an arithmetic logic unit (ALU) 240, and a local or internal memory 248, sometimes called a cache memory. The cache memory 248 typically includes a number of storage registers 244, 245, 246 in a register section storing data 247. One or more internal busses 241 functionally interconnect these functional modules. The processor 205 typically also has one or more interfaces 242 for communicating with external devices via the system bus 204, using a connection 218. The memory 234 is connected to the bus 204 by connection 219.

Application program 233 includes a sequence of instructions 231 that may include conditional branch and loop instructions. Program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, processor 205 is given a set of instructions 243 which are executed therein. The processor 205 then waits for a subsequent input, to which processor 205 reacts by executing another set of instructions. Each input may be provided from one or more of a number of sources, including data generated by one or more of the input devices 202, 203, or 214 when comprising a touchscreen, data received from an external source across one of the networks 220, 222, data retrieved from one of the storage devices 206, 209 or data retrieved from a storage medium 225 inserted into the corresponding reader 212. The execution of a set of the instructions may in some cases result in output of data. Execution may also involve storing data or variables to the memory 234.

The disclosed arrangements use input variables 254 that are stored in the memory 234 in corresponding memory locations 255, 256, 257, 258. The described arrangements produce output variables 261 that are stored in the memory 234 in corresponding memory locations 262, 263, 264, 265. Intermediate variables 268 may be stored in memory locations 259, 260, 266 and 267.

The register section 244, 245, 246, the arithmetic logic unit (ALU) 240, and the control unit 239 of the processor 205 work together to perform sequences of micro-operations needed to perform “fetch, decode, and execute” cycles for every instruction in the instruction set making up the program 233. Each fetch, decode, and execute cycle comprises:

(a) a fetch operation, which fetches or reads an instruction 231 from memory location 228, 229, 230;

(b) a decode operation in which control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the methods of the invention may be associated with one or more segments of the program 233, and may be performed by register section 244-246, the ALU 240, and the control unit 239 in the processor 205 working together to perform the fetch, decode, and execute cycles for every instruction in the instruction set for the noted segments of program 233.

A booking tool host server computer 290 may be connected to the communications network 220 as seen in FIG. 2A.

A travel product server computer 291 may also be connected to the communications network 220.

Although only one host server computer 290 and one travel product server computer 291 are shown, it is to be understood that a plurality of booking tool host server computers 290 and a plurality of travel product server computers 291 may be connected to network 200. Each such server computer 290, 291 may comprise one or more computer modules 201.

As is conventional in the art, typically, server computers 290, 291 respond to requests from personal device 200 and other devices and server computers connected to network 220 to provide information. For example in one embodiment, server computer 291 is operable to respond to a request from personal device 200 and provide time series data so that the time series graphical display 102 may be presented on personal device 200.

Server computer 291 comprises a computer network interface 294 (not shown) that is operable to provide access to network 220. Through interface 294, server computer 291 can send the time series data to the personal device 200 via network 220. Interface 294 also enables server computer 291 to receive the indication from the personal device 200 of the selected one or more travel products.

Server computer 291 may comprise a microprocessor 292 (not shown) and an associated memory or storage device 293 (not shown). The memory 293 may comprise instructions executable by the microprocessor 292 such that, server computer 291 is operable to provide the time series data to the personal device 200; and receive the indication from the personal device 200.

The time series data that is used to construct the time series graphical display 110 may be stored in the associated memory or storage device 293.

The methods of the invention may alternatively be implemented in dedicated hardware such as one or more integrated circuits performing the functions or sub functions of the described methods. Such dedicated hardware may include graphic processors, digital signal processors, or one or more microprocessors and associated memories.

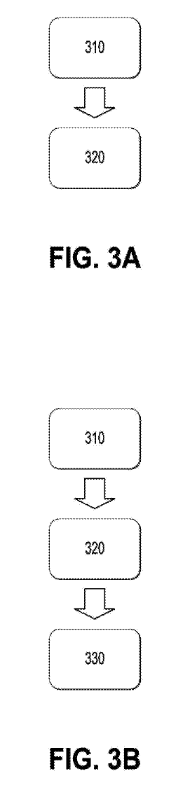

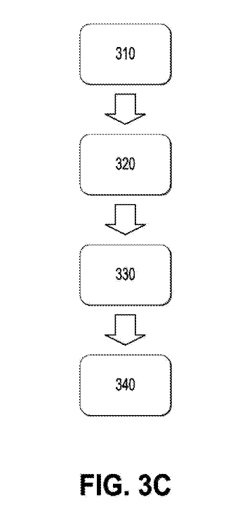

FIG. 3A shows a flowchart illustrating one embodiment of a method 300 for receiving a selection of one or more travel products according to the present invention. In step 310 an initial screen display 102 comprising a time series graphical display 110 of the one or more travel products is provided. As evident from the description of FIGS. 2A and 2B above, the initial screen display 102 may be provided on display 214.

On viewing the initial screen display 102, the user can select one or more travel products by clicking mouse 203 or touching display 214 over a corresponding bar on the bar graph. This selection may be communicated from personal device through network 221, 223 to server computer 291. The communication to server computer 291 may comprise a date or dates for the selected one or more travel products.

In step 320 an indication of the selected one or more travel products present on the graphical display 110 is received in server computer 291. This indication may also be communicated to server computer 291 through network 221, 223.

FIG. 3B shows another embodiment of method 300 which comprises the additional step 330 of providing access to a booking for the indicated one or more travel products. Provision of the access may be by providing respective one or more deep links to an online booking tool or other website in which the selected one or more travel products are entered for booking.

The provision of the one or more deep links may be from the server computer memory 293 which further comprises instructions executable by the microprocessor 292 such that server computer 291 is operable to provide the respective one or more deep links. The one or more deep links may be stored in the associated memory or storage device 293

As is understood in the art, a deep link is not to a home page of the OBT or other website, but instead is to a content page. In the present invention a deep link is to a content page on which the selected one or more travel products is available for booking. Preferably the deep link is to a content page on which the user does not have to enter anything because the selected one or more travel products are listed and may be ordered with minimal interaction. The minimal interaction may be limited to clicking a “book” or “order” or similar button. The skilled person will understand that if payment details are not stored or automatically available, credit card or other payment details may need to be entered.

One or more deep links may be provided for each selected travel product. For example respective deep links may be provided to different booking agents or different providers of a selected flight.

Once received by personal device 200, the one or more deep links may be displayed for opening by a user or may be opened automatically. The displayed one or more deep links may be opened by a user clicking on it.

The address of the deep link may be updated or changed in line with changes in the OBT.

FIG. 3C shows another embodiment of method 300 which includes booking step 340 in which the one or more travel products are booked using the deep linked online booking tool or site. This booking may be accomplished by a user operating personal device 200 to, for example, click a booking button and this click is transmitted to the deep linked site within the OBT or other website.

The site that the deep link points or directs to may be comprised on booking tool host server computer 290 hosting an OBT or similar website.

The embodiment of the invention described above with reference to FIGS. 1 to 3 is with respect to personal device 200 being operated by a user and at least one server computer 291 being operated by a provider of the method of the invention. In this embodiment, the provider is a travel booking agent who provides assistance in booking travel products for the user.

In this embodiment the personal device 200 comprises computer software sufficient to allow interaction with the at least one server computer 291 in the manner described. This software may be stored on personal device 200 permanently, for example, in the form of an application (or “app”) or widget, or may be downloaded from at least one server computer 291 as required.

The personal device 200 computer software running on personal device may comprise computer readable program code devices configured to cause personal device 200 to provide the initial screen display comprising the time series graphical display 110.

Additionally, this personal device software may comprise code devices configured to cause the personal device 200 to receive an indication from the user of the selection.

Also, this personal device software may comprise code devices configured to cause the personal device 200 to send the received indication to at least one server computer 291.

The personal device software may also comprise code devices configured to cause personal device 200 to receive respective one or more deep links to an OBT or other website in which the selected one or more travel products are entered for booking. These deep links may be received from at least one server computer 291.

To enable the booking, the personal device software may also comprise code devices configured to receive from a user of personal device 200 a booking of the one or more travel products. This received booking may comprise a clicking of mouse 203 or touch of touchscreen 214 on a button displayed on screen 214.

In other embodiments personal device 200 may use a third party web-browser, or similar, as is known in the art to interact with at least one server computer 291.

The invention also provides a computer program product that may be run on at least one server computer 291. This server computer program product is for receiving a selection of one or more travel products and comprises a computer usable medium and computer readable program code embodied on said computer usable medium for displaying data.

The server computer program product may comprise computer readable code devices configured to send the time series data to personal device 200 and receive an indication entered on the personal device 200 of the selection.

Optionally, the server computer program product further comprises code devices configured to send the deep links to personal device 200.

The server computer program product may also comprise code devices configured to receive from the personal device a booking of the one or more travel products. These code devices may run on either booking tool host server computer 290 or travel product server computer 291.

Product information associated with each of the one or more travel products may be received by and/or stored on the personal device and/or at least one server computer. Each unit of product information may comprise one or more of price; availability; time of day; demand; date; stopover details; provider; flight number; and alternate airline or accommodation provider offering in that time period.

In one embodiment, product information is received on the personal device 200 from the at least one server computer 291 and/or a host server computer 290 over network 220. The received product information may be stored on the personal device 200 or the at least one server computer 291.

The product information may be supplied to the server computer 291 by the host of an OBT or similar website, the providers of the travel products or by one or more aggregators or computer reservations systems of travel products. In the embodiment shown in FIG. 2A, host server computer 290 hosts an OBT and sends product information to server computer 291 over network 220. Product information may also be calculated by host server computer 290 or personal device 200 from other available product information. For example, the demand for an accommodation product may be calculated as described below.

In this way, product information for flights along with hotel accommodation is stored on server computer 291 ready to be provided to personal device 200. As described in detail below, the product information provided to personal device 200 may be in line with one or more default parameters or customer-specific information so that the initial screen display 110 and time series graphical display is in line with, for example, a client's travel policy and/or preferred suppliers.

The product information may be received at a regular frequency. The frequency may comprise every one, two, three, four, five, six, seven, eight, nine, ten, eleven or twelve hours; or every one, two, three, four, five, six or seven days.

The product information may be obtained from one or more aggregators or computer reservations systems. Suitable computer reservations systems include: ameliaRES; Abacus and Abacus Online: AccelAero; Amadeus; Arnold Travel Technologies; Axess; Concur; Internet Booking Engine; Lightning; KDS: KIU; GetThere; Mercator; Navitaire; PARS/SHARES; Patheo; Radixx; Sabre; Serko; Takeflite; Travel Technology Interactive; TravelSky; Travelport GDS; Tramada Systems; WorldTicket Sell-More-Seats; Worldspan; and XNET.

The product information may be interrogated to find the cheapest option per time period, per day, per carrier for display on graphical display 110.

One or more default parameters may be applied to restrict the time series graphical display 110. The one or more default parameters may be stored on and/or accessed from personal device 200 and/or stored on and/or received from a memory or storage device associated with server computer 291. The default parameter may comprise a preferred airline; a time of day; a departure point; an arrival point; a location; a default return route; a preferred provider; a default date; a price point or range; a city: stopover details; flight number; alternate airline or accommodation provider offering in the same time period; all day offering based on each hour of the day.

Additionally, customer-specific information may be applied to restrict the time series graphical display 110. The customer-specific information may be stored on and/or accessed from personal device 200 and/or stored on and/or received from a memory or storage device associated with server computer 291. The customer-specific information may comprise one or more of present location; and club membership information. The club membership information may comprise one or more of club name; membership number, and membership level.

Initial screen display 110 may also comprise one or more selectable filters. Such a selectable filter may restrict respective one or more travel products. The filter may comprise one or more of a time period; rates; a provider, a preferred provider; a time of day; a departure point; an arrival point; a location; a price point; a price range; or a star rating. The selectable filter may be for a preferred restriction or an excluded restriction. For example, a less convenient airport in a city of origin may be excluded or a preferred departure airport in a city of origin selected.

The rates may be set at for example, negotiated fare rates or default fare rates. For example, a negotiated fare rate may be applied to a user who is part of a corporate entity that has negotiated a discount rate with a provider. The rate will be set at the default or normal published rate for all other users.

Returning to FIG. 1, examples of selectable filters are shown implemented as drop down menus 120, 122 and 124 comprised on graphical display 110. Provider drop down menu 120 allows a user to select a desired provider for a travel product, in this example, an airline. A particular airline may be set as a default.

Time drop down menu 122 allows selection of a departure time range. Selectable ranges include: any time; AM Peak (0500-1000); AM Off Peak (1000-1500); PM Peak (1500-1930); and PM Off Peak (1930-2359). One of these selectable ranges may be set as a default.

Destination drop down menu 124 may be used to select a desired destination. A particular, popular or frequent destination may be set as a default.

Although not shown, display 102 may comprise a reverse button to reverse the displayed routing to enable booking of a home leg of a return flight.

Where a particular product is not available, the field on display 102 may be blank. For example, if there is no flight between a selected origin and destination in the PM Off Peak, nothing will be shown in the respective display field.

Display 102 may include a hover over pop-up display in which information of interest to a user is displayed. The hover over pop-up display may comprise the product information and/or a “book now” button. The “book now” button may be a deep link to the OBT as described above.

Each of the default parameter; customer-specific information; and one or more selectable filters may be settable by a user or administrator or may comprise a drop down menu. Time drop down menu 122 is an example ofa selectable filter that is settable by a user, whereas a negotiated fare rate filter is an example of a selectable filter that is most conveniently set by an administrator. Each user may have one or more profiles in which set default parameters; customer-specific information; one or more selectable filters; and/or number and type of time series graphical displays to provide on the initial screen display are stored. For example, a user may have a “work” and a “personal” profile along with “domestic” and “international” profiles.

This set information and profiles may be stored on device 200 or server computer 291.

The time-series graphical display 110 may be dated from the current date, the next day or from a default date to until a defined period thereafter. As a default, time series graphical display 110 may be dated from the current date. This default date may be reset to a desired date, e.g. the present day, by the user or an administrator.

The defined period thereafter may comprise one, two, three, four, five, six, seven, eight, nine or ten days thereafter; or two, three or four weeks later. In a preferred embodiment, the defined period is three weeks later.

Example travel products that may be selected and/or booked with the present invention comprise a flight, accommodation, car hire or a transfer service. The transfer service may for example be, a service providing transfer from an arrival point to accommodation or from accommodation to a departure point.

The deep linked online booking tool or other website may be operated by a provider of the selected one or more travel products or by a third party.

In one embodiment, the graphical display 110 presents a demand or a price over the time series. There may be a toggle button (not shown) to change between the demand and the price. The demand may be calculated according to a demand algorithm.

The demand algorithm may comprise averaging the price for each day of the week over future months to calculate a benchmark for each weekday and comparing the price for a displayed date with the benchmark for that weekday.

The demand algorithm may use benchmark data. The benchmark data may be obtained by searching for each property within a loaded city. Each of the seven weekdays may searched for every month of the year, i.e. eighty-four time-points comprising a Monday cost; a Tuesday cost; a Wednesday cost; a Thursday cost; a Friday cost; a Saturday cost; and a Sunday cost for each month of the year. These costs may be stored in server computer 291 and used to obtain a Low Cost and a High Cost for each property within a loaded city on each day of the week: i.e. seven Low Cost values and seven High Cost values, one for each day of the week.

These Low Cost values and High Cost values may then be used to calculate the percentage change between each property's lowest and highest rate and the benchmark high and low cost for that city for that day over all properties.

The demand may be displayed as the percentage change or as a Demand Level. The Demand Level may be a score between 1 and 10, as shown in Table 1 below.

TABLE 1
Example Demand Level Scores

| | |
|---|---|
| −100+ | 10 |
| −90-99.99 | 0.50 |
| −80-89.99 | 1 |
| −70-79.99 | 1.5 |
| −60-69.99 | 2 |
| −50-59.99 | 2.5 |
| −40-49.99 | 3 |
| −30-39.99 | 3.5 |
| −20-29.99 | 4 |
| −10-19.99 | 4.5 |
| 0-−9.99 | 5 |
| 0-9.99 | 5 |
| 10-19.99 | 5.5 |
| 20-29.99 | 6 |
| 30-39.99 | 6.5 |
| 40-49.99 | 7 |
| 50-59.99 | 7.5 |
| 60-69.99 | 8 |
| 70-79.99 | 8.5 |
| 80-89.99 | 9 |
| 90-99.99 | 9.5 |
| 100+ | 10 |

The benchmark data may be obtained every month. The benchmark data may be obtained from one or more aggregators or computer reservations systems as detailed above. The benchmark data may, for example, be obtained at 0100 on the first Sunday of each month.

A toggle button may be comprised on a screen display 102 which allows a user to implement the demand algorithm for accommodation.

The time series graphical display 110 may also comprise one or more indicators of selection drivers. Such an indicator of selection driver may comprise a colour. Different colours may be used to indicate different drivers. For example, a first colour may be used to indicate adesirable selection driver such as, an inexpensive price and/or low demand. A second colour may be used to indicate an undesirable selection driver such as an expensive price and/or high demand. A third colour may be used to indicate a moderate selection driver, such as used when taking a moderate or conservative approach, such as a price that is neither low or high and/or demand that is neither high or low. In one embodiment a desirable selection driver is coloured green; an undesirable selection driver is coloured red and a moderate selection driver is coloured blue.

The data generated when a search of product information is performed is stored until the next search is initiated. The old data may then be deleted and replaced with the new data stored on host server computer 290.

Advantageously, the present invention is dynamic and responsive. The method, device and systems may be accessed anywhere, anytime and on any device. This will lead to higher levels of customer productivity due to ease of accessibility from, for example, work, home, bus or train.

The method, device and systems of the invention are highly usable and intuitive. This eliminates the need for manuals and training and means quicker response times, easier implementation and increased ease of extraction of important content. These advantages have significant time and cost savings.

Yet another advantage of the present invention is that the centralised access to all the technology and features means that it is convenient, easy to use and personalised or personalisable. The method, including the initial screen display 102, can be personalised so that only content of interest is presented. This can result in increased internal adoption, increased stickiness, enhanced customer satisfaction and a unique corporate travel approach.

A key advantage of the present invention is that a user can extract insight before even entering the OBT. The benefit of this is booking funnel productivity times may be boosted by thirty seconds or more. This reduces costs and OBT clicks. Conventional OBTs only provide access to rates based on what you search for on that day or one or two days around the search date. The present invention makes it possible to see costs on an initial screen and these costs can be provided in a graphical manner, for example, for 21 days. The present invention thus provides a more insightful mechanism for determining the cheapest time to book.

The present invention provides enhanced functionality with OBTs, not merely around the OBT. As such, the present invention reduces the reliance on OBTs and incrementally adds value to the experience.

Any one or more default parameters; customer-specific information; and one or more selectable filters may be set, saved and/or grouped together. The functional design of the present invention is such that there is complete flexibility.

Throughout the specification, the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

1. A method for receiving a selection of one or more travel products comprising or consisting of:
providing an initial screen display comprising a time series graphical display of the one or more travel products; and
receiving an indication of selected one or more travel products present on the graphical display to thereby receive the selection of the one or more travel product.

2. The method of claim 1 further comprising providing direct access to a booking for the indicated one or more travel products.

3-12. (canceled)

13. A method for providing access to a booking of one or more travel products comprising or consisting of:
providing an initial screen display comprising a time series graphical display of the one or more travel products;
receiving an indication of selected one or more travel products present on the graphical display; and
supplying respective one or more deep links to an online booking tool or site in which the selected one or more travel products are entered for booking.

14-18. (canceled)

19. A method for booking one or more travel products comprising:
providing an initial screen display comprising a time series graphical display of the one or more travel products;
receiving an indication of selected one or more travel products present on the graphical display;
supplying respective one or more deep links to an online booking tool or site in which the selected one or more travel products are entered for booking; and
booking the selected one or more travel products on the online booking tool or site to thereby book the one or more travel products.

20-22. (canceled)

23. The method according to claim 1 wherein the initial screen display is the first screen displayed to a user upon opening an application programme or opening a website.

24. (canceled)

25. The method according to claim 1 wherein the graphical display presents a demand or a price over the time series.

26. The method according to claim 25 wherein the demand is calculated according to a demand algorithm.

27-32. (canceled)

33. The method according to claim 1 wherein one or more profile is associated with a user and each one or more profile stores default parameters; customer-specific information; one or more selectable filter and/or number and type of time series graphical displays to provide on the initial screen display.

34-35. (canceled)

36. The method according to claim 1 wherein the initial screen display comprises three time series graphical displays wherein each of the three time series graphical displays comprise an outbound flight display; a return flight display; and an accommodation display.

37. The method according to claim 13 wherein the initial screen display is the first screen displayed to a user upon opening an application programme or opening a website.

38. The method according to claim 13 wherein the graphical display presents a demand or a price over the time series.

39. The method according to claim 38 wherein the demand is calculated according to a demand algorithm.

40. The method according to claim 13 wherein one or more profile is associated with a user and each one or more profile stores default parameters; customer-specific information; one or more selectable filter and/or number and type of time series graphical displays to provide on the initial screen display.

41. The method according to claim 13 wherein the initial screen display comprises three time series graphical displays, wherein each of the three time series graphical displays comprise an outbound flight display; a return flight display; and an accommodation display.

42. The method according to claim 19 wherein the initial screen display is the first screen displayed to a user upon opening an application programme or opening a website.

43. The method according to claim 19 wherein the graphical display presents a demand or a price over the time series.

44. The method according to claim 43 wherein the demand is calculated according to a demand algorithm.

45. The method according to claim 19 wherein one or more profile is associated with a user and each one or more profile stores default parameters; customer-specific information; one or more selectable filter and/or number and type of time series graphical displays to provide on the initial screen display.

46. The method according to claim 19 wherein the initial screen display comprises three time series graphical displays, wherein each of the three time series graphical displays comprise an outbound flight display; a return flight display; and an accommodation display.
